(19) United States
(12) Patent Application Publication
(10) Pub. No.: US 2015/0104362 A1
(43) Pub. Date: Apr. 16, 2015

(54) METHODS AND APPARATUS FOR RECOVERING MOLYBDENUM IN URANIUM IN-SITU RECOVERY PROCESS

(71) Applicant: Mestena Operating, Ltd., Corpus Christi, TX (US)

(72) Inventor: Pablo Avila, Corpus Christi, TX (US)

(21) Appl. No.: 14/505,030

(22) Filed: Oct. 2, 2014

Related U.S. Application Data
(60) Provisional application No. 61/885,945, filed on Oct. 2, 2013.

(51) Int. Cl. C22B 34/34; B01J 19/00

(52) U.S. Cl. CPC C22B 34/34; B01J 19/0053; B01J 2219/00479
USPC 423/54; 422/618

(57) ABSTRACT

A method of recovering molybdenum includes introducing resin comprising molybdenum anions into an elution vessel and eluting (separating) the molybdenum anions from the resin to form a molybdenum rich eluent. Small amounts of uranium within the eluent is precipitated into sodium diuranate and removed. A further precipitation process is performed to form ferrimolybdate from the molybdenum rich eluent, thus recovering molybdenum. The resin comprising the molybdenum anions may be generated by (1) moving a pregnant lixiviant (containing uranium and molybdenum) through a first extraction apparatus to capture uranium anions in resin and producing a barren lixiviant (containing mostly molybdenum, with small amount of uranium), and (2) moving the barren lixiviant through a second extraction apparatus to capture mostly molybdenum anions in resin.

### CROSS-REFERENCE TO RELATED APPLICATION(S) AND CLAIM OF PRIORITY

The present application claims priority under 35 U.S.C. §119(e) to U.S. Provisional Patent Application No. 61/885,945, filed Oct. 2, 2013, entitled “METHOD AND APPARATUS FOR RECOVERING MOLYBDENUM IN URANIUM IN-SITU RECOVERY PROCESS,” the contents of which are incorporated herein by reference.

### TECHNICAL FIELD

The present application relates generally to the recovery of certain elements and compounds and, more specifically, to methods of recovering molybdenum in a uranium in-situ recovery process.

### BACKGROUND

In uranium in-situ recovery mining processes, molybdenum is often co-extracted and absorbed into anion exchange resins. Although, molybdenum may be eluted from the resin in a similar process by which uranium is eluted, there are no methods to precipitate molybdenum in the presence of significant uranium without co-precipitating uranium. Molybdenum is required to be separated from uranium at a high level of purity in order to produce marketable molybdenum free of uranium contamination. In uranium mining solutions, molybdenum is found in a soluble molybdate form which may be precipitated as ferrimolybdate using ferric chloride or ferric sulfate. Because the precipitation with a ferric compound is not 100% molybdate selective, co-precipitation of uranium occurs, thus contaminating the molybdenum.

Accordingly, novel methods of recovering molybdenum in uranium in-situ recovery process are needed to effectively reduce or eliminate co-precipitation of uranium.

### SUMMARY

According to disclosed embodiments, there is provided a method of recovering molybdenum, including introducing resin comprising molybdenum anions into an elution vessel, and eluting molybdenum anions from the resin to form a molybdenum rich eluent. Uranium, which is also recovered during the process, is precipitated from the eluent in the form of sodium diuranate and removed. A precipitation process is performed to form ferrimolybdate from the molybdenum rich eluent in order to recover molybdenum.

In one embodiment, there is provided a method of recovering molybdenum from a molybdenum rich eluent. The method includes introducing a molybdenum rich eluent into a tank (the molybdenum rich eluent includes molybdenum anions and uranium anions); freeing the uranyl ions from the uranium anions within the eluent; precipitating the uranyl ions in the form of sodium diuranate; removing the precipitated uranium from the eluent; and forming ferrimolybdate from the molybdenum anions in the eluent to recover molybdenum.

According to disclosed embodiments, a method of recovering molybdenum includes moving a molybdenum loaded resin to another vessel (or using the same vessel) to remove the molybdenum by desorption. The method also includes transferring the molybdenum eluent to a tank, adding sodium chloride to the molybdenum eluent to refortify the molybdenum eluent, and transferring the refortified molybdenum to a through another loaded vessel to recover additional molybdenum. In yet another embodiment, a method includes transferring the molybdenum eluent to a second tank, adding acid and caustic acid to the eluent to produce sodium diuranate, and processing the sodium diuranate to produce yellowcake.

The above-described embodiments may further include moving a wellfield lixiviant through a first extraction apparatus to capture uranium by adding a strong base anion exchange resin to the first extraction apparatus and moving the wellfield lixiviant (with uranium and molybdenum therein) through the apparatus to produce a barren lixiviant, wherein the barren lixiviant is produced by removing a majority of uranium from the wellfield lixiviant. The method includes transferring the barren lixiviant to a second extraction apparatus and adding a strong base anion exchange resin to the second extraction apparatus and moving the barren lixiviant through the apparatus to capture molybdenum from the barren lixiviant. This may include moving the barren lixiviant through additional extraction apparatuses to further remove the molybdenum from the barren lixiviant.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a molybdenum ion exchange and recovery apparatus/process according to disclosed embodiments; and

FIG. 2 illustrates a molybdenum elution and recovery apparatus/process according to disclosed embodiments.

### DETAILED DESCRIPTION OF THE INVENTION

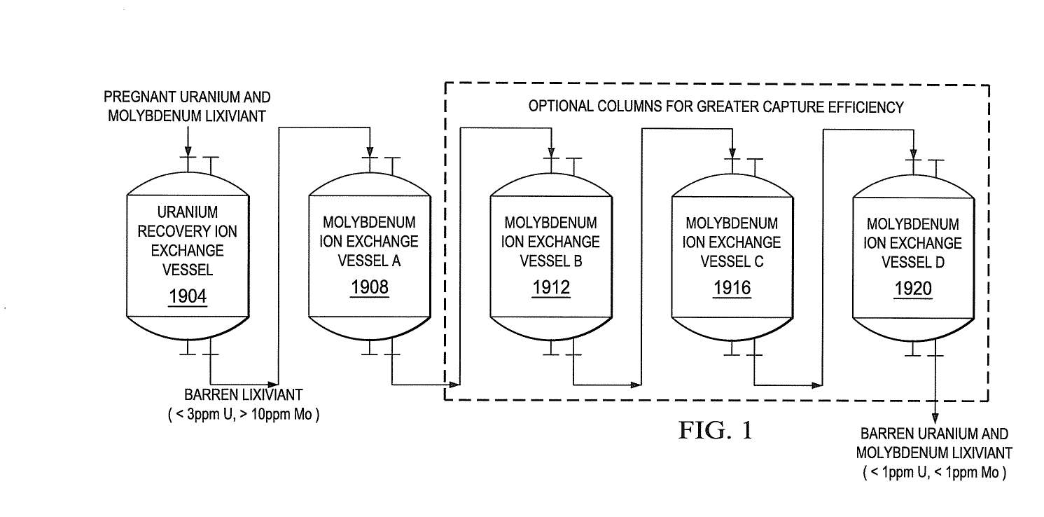

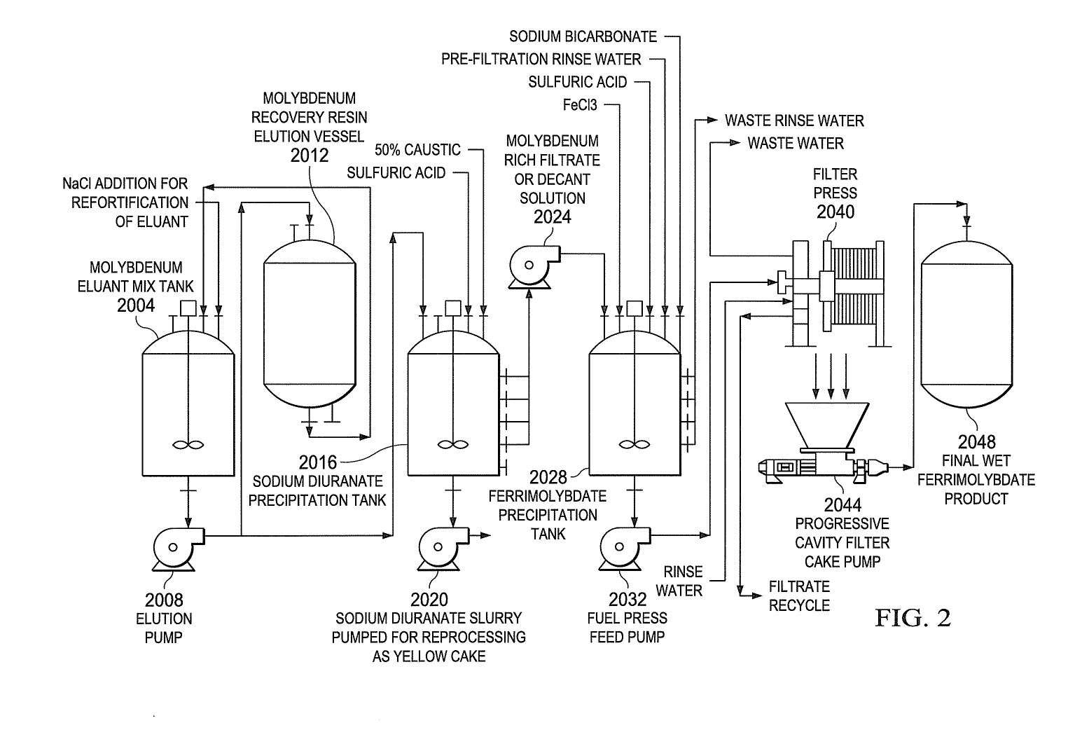

FIGS. 1 through 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged to recover elements from various sources.

In some embodiments, systems and methods are disclosed herein that promote extraction of transition metals from various sources. When not otherwise specified herein, “resin” is may be used to refer to a resin comprising a strong base anion. Examples of resins are given throughout the present specification. It is contemplated that any resin, or element, structure, or compound capable of performing the functions described herein may be used.

These systems and methods may be used to extract various elements and compounds, such as transitional metals including, but not limited to, molybdenum.

In accordance with embodiments, the following provides a general description of various methods and processes disclosed herein. There are provided one or more processes in which molybdenum is captured, separated and precipitated (i.e., produced) in an alkaline uranium in-situ recovery process. In general terms, these processes include two main processes: (1) molybdenum ion exchange recovery, and (2) molybdenum elution and processing.

The inventors have discovered a new method of recovering and producing molybdenum from a sodium uranyl carbonate solution obtained by the alkaline carbonate in-situ leaching of uranium ore. By placing ion exchange resin for molybdenum and uranium recovery in the proper sequence, eluting the molybdenum anion resin at the appropriate times, separating the uranium from the molybdenum rich solution, and precipitating the molybdenum, a low uranium molybdenum compound can be generated at a minimal production cost.

After a majority of uranium is removed from a pregnant wellfield lixiviant (which contains uranium and molybdenum) utilizing a relatively strong base anion exchange resin within one or more uranium ion exchange columns, molybdenum is removed from the resulting barren lixiviant (containing a small amount of uranium and larger amount of molybdenum) in large concentrations by one or more subsequent ion exchange columns which utilize the same (or similar) relatively strong base anion exchange resin.

The molybdenum extraction columns (i.e., the vessels containing resin for recovering molybdenum) are subsequently eluted with a sodium chloride solution to remove or strip the molybdenum. As a result, a rich molybdenum eluate is obtained after multiple elutions using the same type of solution. The resulting desorbate (or eluent solution) may contain a high concentration of molybdenum and relatively high concentration of uranium. In order to precipitate the molybdenum, most of the remaining uranium is removed from the solution first, in order to prevent co-precipitation of the uranium while precipitating the molybdenum, thus preventing or substantially reducing the likelihood of uranium contamination of the molybdenum product.

The aforementioned process significantly reduces uranium and avoids uranium contamination in compliance with regulatory standards. In this process, the uranium content may be reduced to less than 0.05%. The resulting molybdenum-rich solution is precipitated to produce a marketable molybdenum product. According to disclosed embodiments, uranyl carbonate complexes (uranium) in rich molybdenum/desorbates are converted into uranyl ions, which are then efficiently precipitated as sodium diuranate. The precipitate is filtered out of the solution or separated by centrifugation, or allowed to settle to the bottom where the solution can be decanted. As a result, uranium in solid precipitate form is separated from the molybdenum which remains in the solution. Thus, the molybdenum solution becomes essentially uranium free and rich in molybdenum. The rich molybdenum solution is thereafter precipitated as ferrimolybdate using a concentrated ferric chloride solution. The separated sodium diuranate precipitate (having the uranium) can be re-dissolved with concentrated acid and re-precipitated as yellowcake (U308) using hydrogen peroxide. Thus, this process also benefits by recovering additional uranium.

According to disclosed embodiments, both molybdenum and uranium are recovered by one or more strong base anion exchange resins in separate capturing columns disposed in series. The bulk of the uranium is captured upstream of the molybdenum capturing process. A strong base anion exchange resin, such as, for example, Dow Chemical Company's DOWEX™ 21K XLT anion exchange resin loads uranium as well as molybdenum. The inventors have learned that after several hours of absorption using the resin, molybdenum anions becomes desorbed by incoming uranium anions. In other words, over time, the absorbed molybdenum ions gets replaced (or substituted) with uranium anions. Consequently, the resin's selectivity favors the uranium anion as opposed to the molybdenum anion. As a result, in a series of ion exchange columns, maximum molybdenum recovery occurs downstream of the uranium recovery because the uranium barren lixiviant (generated from at least one uranium extraction column) contains the least amount of uranium in the process. Because recovery of molybdenum is conducted using a strong base resin that is selective to uranium, the efficiency of molybdenum recovery may be lower than it is for uranium (at least during the beginning of the ion exchange process).

According to disclosed embodiments, over 75% of the molybdenum may be extracted from the uranium barren lixiviant using one or more ion exchange columns in series. According to disclosed embodiments, recovery efficiency increases with a higher Mo:U ratio and decreases with a lower Mo:U ratio. Consequently, utilization of additional ion exchange columns in series increases the capture efficiency, while fewer decreases capture efficiency. In one disclosed embodiment, after several elutions of a molybdenum extracting column, an eluent rich in molybdenum and uranium is produced. When a target concentration of captured molybdenum is achieved, further processing occurs to isolate or separate the uranium from the molybdenum.

According to one embodiment, to obtain this separation, the pH of the eluent is lowered to a level adequate to convert the uranyl carbonate complexes into uranyl ions. In one example, this may be accomplished by adding acid as set forth in the equations below:

UO₂(CO₃)₃⁻⁴+6H⁺---------→UO₂²⁺+3CO₂+3H₂O

UO₂(CO₃)₂²+4H⁺---------→UO₂²⁺+2CO₂+2H₂O

Lowering the pH to less than about 4 will produce the foregoing results if the solution is agitated for an extended period of time to allow for carbon dioxide to be liberated. Lowering the pH to about 1 will speed up the process significantly. In various embodiments, sulfuric acid may be used to convert the uranyl carbonate into uranyl ions due to cost advantages. Alternatively, if there is a high presence of sulfate in the eluent, concentrated HCl or HNO3 may be used for the conversion.

This process of converting the uranyl carbonate to uranyl ions provides a means or method for extracting or converting the uranium into sodium diuranate. A sufficient amount of sodium hydroxide is added to precipitate the sodium diuranate. According to disclosed embodiments, to precipitate the uranium, a pH around 10 or above may be required to achieve substantial conversion. In some instances, where pH continues to increase above 10 after incremental addition of sodium hydroxide, further additions of sodium hydroxide preferably should continue until the pH reaches around 12 (or more) or when the pH ceases to increase, even with further addition of sodium hydroxide. The equation for conversion of uranyl ions to sodium diuranate with the addition of NaOH is set forth below:

2Na₂[UO₂(SO₄)₂]+6NaOH--------→Na₂U₂O₇+4Na₂SO₄+3H₂O

Using the process, the conversion of the uranium to sodium diuranate is efficient, even at a concentration of uranium below 0.5 g/L.

It should be noted that sodium hydroxide could be used to precipitate the sodium diuranate from uranyl carbonate complexes (instead of first converting the uranyl carbonate complexes to uranyl ions), but this process takes a long time and the reaction is not efficiently complete. Further, precipitation with hydrogen peroxide is not preferred because low concentrations of uranium are difficult to precipitate and any significant amounts of uranium not removed will contaminate a ferrimolybdate precipitate.

After the uranium is precipitated, the precipitate is filtered or separated from the solution. This may be accomplished by centrifugation or other suitable process. In one embodiment, the precipitate is allowed to settle to the bottom and the remaining molybdenum rich solution may be decanted. This “uranium free” (molybdenum rich) solution may then be transferred to another location where a ferrimolybdate product is precipitated/generated free of uranium contamination. Meanwhile, the sodium diuranate precipitate (containing uranium) may be re-dissolved with acid and re-precipitated as yellowcake to recover the uranium. The molybdenum rich solution is then processed to recover the molybdenum using a ferrimolybdate generating process.

In one embodiment, the process of precipitating the ferrimolybdate includes several steps. This process includes lowering the pH of the solution to between about 2 and 3, and more preferably, around 2.3. One way of lowering the pH is to add sulfuric acid, or other suitable pH decreasing product, to the solution. The method includes adding 5-10%, excess ferric chloride in a calculated weight ratio amount of about: 0.4 lb Fe:1 lb molybdenum. Analysis of the molybdenum solution will provide the amount of molybdenum in the solution, and then the proper amount of iron (in chloride solution) is added to achieve the above ratio. Adding excess ferric chloride causes ferric sulfate precipitation when there is a high presence of sulfates in the solution.

The addition of ferric chloride will lower the pH of the solution, which will normally drop the pH to below about 2. To maintain the pH in the range of about 2 to 3, one way is to raise the pH by adding sodium bicarbonate, or other suitable pH increasing product, to the solution. Thus, while the ferric chloride is added, sodium bicarbonate is also added in amounts suitable to maintain the pH between about 2 and 3, and preferably about 2.3. While sodium bicarbonate is preferred in one embodiment, other suitable products may be used. Utilization of sodium hydroxide to increase pH will cause iron to precipitate with the molybdate, so this product should be avoided.

According to this process, at a 6 g/L molybdenum concentration, it is estimated that 80-90% of the molybdenum may be converted to ferrimolybdate. Below 6 g/L, the conversion rate drops to about 50% (e.g., at 5 g/L). In one embodiment, it is preferred to maintain the concentration at 6 g/L or higher, and higher conversion rates may be achieved at higher molybdenum concentration. The equation for ferrimolybdate conversion is set forth below:

3Na₂MoO₄+2FeCl₃-----→Fe₂Mo₃O₁₂+6NaCl

It will be understood this conversion process generates new NaCl (e.g., 6 moles of NaCl per mole of Fe₂Mo₃O₁₂), and the final precipitated molybdenum product may contain undissolved salt if the initial concentration of NaCl and the newly formed NaCl increases the concentration above saturation. Consequently, excess rinse water may be applied to wash off the salt if the ferrimolybdate is filtered through a filtered press. Alternatively, the precipitated ferrimolybdate may be allowed to settle, and then the fluid decanted and fresh water introduced to mix with the precipitate to dissolve the NaCl prior to filtering the ferrimolybdate.

Now turning to FIG. 1, there is illustrated a molybdenum (and uranium) ion exchange and recovery apparatus/process 1900 according to disclosed embodiments. The apparatus 1900 includes a first ion exchange vessel (or column) 1904 and a second ion exchange vessel (or column) 1908, as shown. A “pregnant” lixiviant, which includes both uranium and molybdenum therein, is input or transferred to the vessel 1904. As the pregnant lixiviant is moved through the vessel 1904, a majority of uranium is removed or separated from the pregnant lixiviant using a strong base anion exchange resin disposed therein. One suitable resin is available from the Dow Chemical Company, and marketed and sold under the name DOWEX™ 21K XLT. In one embodiment, the base anion exchange resin has a selectivity that favors (or selects), at least over time, uranium anions as opposed to molybdenum anions. This process isolates or removes most of the uranium and generates a “barren” lixiviant, which includes molybdenum and generally includes a small amount of uranium therein.

The barren lixiviant is input or transferred to the second ion exchange vessel 1908. As the barren lixiviant is moved through the vessel 1908, a majority of the molybdenum (and a majority of the remaining small amount of uranium) is removed or separated from the received barren lixiviant using a strong base anion exchange resin disposed therein. One suitable resin is available from the Dow Chemical Company, and marketed and sold under the name DOWEX™ 21K XLT. During this process, molybdenum adsorption is monitored periodically (e.g., hourly) by sampling the column input and output solutions. As will be appreciated, the base anion exchange resin utilized in the second exchange vessel 1908 can be the same or similar type of resin utilized in the first exchange vessel 1904. In one embodiment, it is the same.

Shown in dotted lines in FIG. 19 are optional downstream molybdenum ion exchange vessels 1912, 1916, 1920. These additional exchange vessels may be utilized to achieve additional/higher capture efficiency of molybdenum, and the molybdenum removal process in these vessels is similar to that described above with respect to vessel 1908.

When sufficient or maximum molybdenum adsorption is achieved, the molybdenum anions captured (by the resin) in the molybdenum vessel 1908 (and vessels 1912, 1916, 1920, if utilized) are subsequently processed to recover the molybdenum. As will be appreciated, further processing can take the form of processing the entire vessel 1908, or removing and processing the resin/molybdenum anion material itself in another apparatus, or removing and processing the molybdenum eluent in another apparatus. In one embodiment, the vessel 1908 is taken offline and further processed as described below.

Now turning to FIG. 2, there is illustrated a molybdenum elution and recovery process 2000 according to disclosed embodiments. Molybdenum loaded resin (e.g., resin including captured molybdenum anions) is introduced into a recovery resin elution vessel 2012. In the recovery resin elution vessel 2012 containing the captured molybdenum anions on resin, a sodium chloride (NaCl) based eluent solution from a tank 2004 is used to remove the molybdenum anions from the resin. This may take the form of multiple stages using the same eluent. An elution pump 2008 pumps the eluent through the recovery resin elution vessel 2012 to generate a molybdenum rich eluent. Additional sodium chloride may be added to the eluent after each elution to fortify the concentration of brine for stripping the resin. As will be appreciated, the vessel 2012 may be the same physical vessel 1908 with the molybdenum loaded resin therein, or a different vessel having the previously captured molybdenum transferred thereto.

The molybdenum rich eluent (with some uranium) is then processed to remove/separate the uranium from the solution. To accomplish this, a sodium diuranate precipitation tank 2016 is utilized and receives this molybdenum rich eluent. The pH of the eluent is decreased to a level adequate to convert the uranyl carbonate complexes into free uranyl ions. In different embodiments, the pH of the solution is lowered to about 4 or below, in the range of between about 4 and 1, or about 1 or lower. In one example, this may be accomplished by adding acid, or other suitable pH lowering product, to the eluent in the tank 2016. Lowering the pH to less than about 4 is acceptable, and will produce the foregoing results if the solution is agitated for an extended period of time to allow for carbon dioxide to be liberated. Lowering the pH to about 1 will speed up the process significantly (and may eliminate the need for agitation). In one embodiment, sulfuric acid is used to remove the carbonates from the uranyl ions. Alternatively, concentrated HCl or HNO₂ may be used for the conversion.

This process of converting the uranyl carbonate anions to uranyl ions enables conversion of the uranium into sodium diuranate. Sodium diuranate is formed or precipitated by adding a sufficient amount of sodium hydroxide (caustic) to the eluent solution. To precipitate the uranium, according to disclosed embodiments, sodium hydroxide is added to increase pH to around 10 or above. This assists in achieving substantial conversion and precipitation. In another embodiment the pH is increased to around 12 or above. In some instances, the pH may continue to increase above 10 after incremental addition of sodium hydroxide. In such cases, further additions of sodium hydroxide preferably should continue until the pH reaches around 12 or more or when the pH increase ceases, even with a further addition of sodium hydroxide. Using the process, the conversion of uranium into sodium diuranate is efficient, even at a concentration of uranium below 0.5 g/L.

Once converted, the sodium diuranate slurry (containing the uranium) is removed by a pump 2020, and can be reprocessed as yellow cake to recover the uranium. Alternatively, or in addition to this, the molybdenum rich solution in the precipitation tank 2016 may be decanted or filtered and transferred by pump 2024 to a ferrimolybdate precipitation tank 2028.

The “uranium free” (molybdenum rich) solution is then processed to recover the molybdenum using a ferrimolybdate precipitation process. In the tank 2028, the solution is converted into a ferrimolybdate product—virtually free of uranium contamination.

In one embodiment, the process of generating or precipitating ferrimolybdate includes several steps. The first step is to lower the pH of the solution to between about 2 and 3, and more preferably, around 2.3. In one embodiment, the pH is lowered by adding sulfuric acid (or other suitable pH decreasing product) to the solution. Next, 5-10% excess ferric chloride is added to the solution in a calculated weight ratio amount of about: 0.4 lb Fe: 1 lb molybdenum. Analysis or measurement of the molybdenum solution will identify the amount of molybdenum in the solution, and then the proper amount of iron (in chloride solution) is added to achieve the above ratio.

Because the addition of ferric chloride will lower the pH of the solution (which will normally drop the pH to below about 2), sodium bicarbonate (or other suitable pH increasing product) is added to maintain the pH in the range of about 2 to 3. Thus, while the ferric chloride is added, sodium bicarbonate is also added in amounts suitable to maintain the pH between about 2 and 3, and preferably about 2.3. While sodium bicarbonate is preferred in one embodiment, other suitable products may be used.

According to this process, at a 6 g/L molybdenum concentration, it is estimated that 80-90%, of the molybdenum may be converted to ferrimolybdate. Higher conversion rates may be achieved at higher molybdenum concentration. In certain embodiments, because the conversion efficiency of the process drops significantly with a drop in molybdenum concentration, the target concentration of molybdenum in the solution should be in the range of about 5 g/L or greater, or about 6 g/L or greater, to beneficially recover the molybdenum.

As noted previously, because this generates new NaCl, the precipitated molybdenum product may contain undissolved salt if the initial concentration of NaCl and the newly formed NaCl increases the concentration above saturation. Thus, an optional step in the process includes adding additional rinse water to wash and dissolve the salt, in the event the ferrimolybdate is filtered through a filter press. Alternatively, the precipitated ferrimolybdate may be allowed to settle, and then the fluid decanted and fresh water introduced to mix with the precipitate to dissolve the NaCl prior to filtering the ferrimolybdate.

From the tank 2028, the precipitated ferrimolybdate is transferred (e.g., by a pump 2032) to a filtering apparatus 2040 that filters the ferrimolybdate. In one embodiment, the filtering apparatus may be a filter press of the type conventionally used for yellowcake processing. A progressive cavity filter cake pump 2044 may transfer the final wet ferrimolybdate product to a vessel 2048. As will be appreciated, the ferrimolybdate product is the final product with molybdenum therein. The molybdenum may then be separated by conventional methods known to those skilled in the art.

The description below provides one example of the molybdenum recovery process described herein. In this example, a barren lixiviant flowing at 1600 gallons per minute was provided, with the lixiviant containing less than 2 ppm uranium and 30 ppm molybdenum. Two molybdenum ion exchange columns 1908 were piped in parallel downstream of the uranium ion exchange column(s) 1904. Approximately 400 cubic feet of Dow Chemical Company's 21K XLT resin were added in the molybdenum ion exchange columns 1908 to capture molybdate anions. Molybdenum adsorption was monitored hourly by sampling column inlet and outlet solutions. When high molybdenum adsorption was achieved, the columns 1908 were taken offline and eluted with three (3) stages of 10,000 gallons of 70 g/L NaCl eluent. After several elutions using the same eluent, a molybdenum rich eluent was produced, with approximately 6 g/L molybdenum and 4 g/L uranium.

Sodium chloride (NaCl) was added to the eluent after elution in order to fortify the concentration of brine for stripping the resin.

The resulting molybdenum rich eluent (10,000 gallons) was transferred to the precipitation tank 2016 equipped with a mixer to begin the next step of removing the uranium from the solution. One hundred (100) gallons of 986 sulfuric acid were added to the eluent dropping the pH to below 1 which converted the uranyl carbonate complexes to uranyl ions. Thereafter, the pH of the eluent was raised to 10.5 by adding 150 gallons of 50% NaOH which initiated precipitation of sodium diuranate. After agitation for 30 minutes, the resulting precipitate was allowed to settle for a minimum of 12 hours. The molybdenum rich fluid was decanted and transferred to the tank 2028 in which 100 gallons of sulfuric acid were added to lower the pH of the solution to about 2.3. Then, approximately 200 gallons of 47% ferric chloride were slowly added to the solution. As the pH dropped, sodium bicarbonate was added to control the pH at approximately 2.3. After stabilization of the pH, the solution was agitated in the tank 2028 for 4 hours to allow the slow reaction to complete and form ferrimolybdate. The solution was then pumped through a 6 cubic feet filter press 2040 where the ferrimolybdate precipitate was filtered out of the solution to generate molybdenum filter cake. Four to five thousand gallons of rinse water were used to wash the molybdenum filter cake in the filter press to remove the sodium chloride. The final rinsed ferrimolybdate filter cake was then removed from the filter press 2040. Analysis of the filter cake indicated it contained less than 0.008% uranium.

It is expressly understood that any number of extraction apparatuses may be used with any number or resins to extract any number of materials from a fluid. The use of the preceding examples of uranium and molybdenum should not be construed as limiting, but rather as exemplary.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of recovering molybdenum, the method comprising:
introducing resin comprising molybdenum anions into an elution vessel;
eluting molybdenum anions from the resin to form a molybdenum rich eluent;
precipitating uranium within the molybdenum rich eluent into sodium diuranate;
removing the precipitated sodium diuranate from the molybdenum rich eluent; and
performing a precipitation process to form ferrimolybdate from the molybdenum rich eluent to recover molybdenum.

2. The method in accordance with claim 1 wherein precipitating uranium into sodium diuranate further comprises:
lowering the pH of the eluent to about 4 or less; and
raising the pH of the eluent to about 10 or more.

3. The method in accordance with claim 2 wherein lowering the pH of the eluent to about 4 or less comprises:
adding sulfuric acid.

4. The method in accordance with claim 3 wherein raising the pH of the eluent to about 10 or more comprises:
adding sodium hydroxide.

5. The method in accordance with claim 1 wherein performing the precipitation process to form ferrimolybdate further comprises:
lowering the pH of the eluent to between about 2 and 3.

6. The method in accordance with claim 5 wherein performing the precipitation process to form ferrimolybdate further comprises:
adding ferric chloride.

7. The method in accordance with claim 6 wherein performing the precipitation process to form ferrimolybdate further comprises:
maintaining the pH of the eluent between about 2 and 3 while the ferric chloride is being added.

8. The method in accordance with claim 7 wherein maintaining the pH of the eluent between about 2 and 3 while the ferric chloride is being added comprises:
adding sodium bicarbonate.

9. The method in accordance with claim 1 further comprising:
moving a wellfield lixiviant through a first extraction apparatus, the wellfield lixiviant comprising uranium and molybdenum;
capturing a substantial portion of uranium as uranium anions from the wellfield lixiviant using a first base anion exchange resin within the first extraction apparatus to generate a barren lixiviant, the barren lixiviant comprising molybdenum and a remaining amount of uranium;
moving the barren lixiviant through a second extraction apparatus; and
capturing a substantial portion of the uranium as uranium anions and a substantial portion of molybdenum as molybdenum anions using a second base anion exchange resin and forming the resin with molybdenum anions.

10. A method of recovering molybdenum from a molybdenum rich eluent, the method comprising:
introducing a molybdenum rich eluent into a vessel, the molybdenum rich eluent comprising molybdenum anions and uranium anions;
forming uranyl ions from the uranium anions within the eluent;
precipitating uranium from the uranyl ions;
removing the precipitated uranium from the eluent; and
forming ferrimolybdate from the molybdenum anions in the eluent to recover molybdenum.

11. An apparatus for recovering molybdenum, the apparatus comprising:
an elution vessel configured to receive resin comprising molybdenum anions and remove the molybdenum anions from the resin;
an eluent mix tank and an eluent pump coupled to the elution vessel and configured for pumping eluent through the resin to generate a first eluent comprising molybdenum anions;
a first precipitation tank configured to receive the first eluent comprising molybdenum and at least one chemical to precipitate sodium diuranate from the first eluent and generate a second eluent; and
a second precipitation tank configured to receive the second eluent and at least one chemical to form ferrimolybdate from the second eluent.

12. The apparatus in accordance with claim 11 wherein the first precipitation tank is configured to precipitate sodium diuranate from the first eluent by:
lowering the pH of the first eluent to about 4 or less; and
raising the pH of the first eluent to about 10 or more.

13. The apparatus in accordance with claim 12 wherein the first precipitation tank is configured to lower the pH of the first eluent to about 4 or less by adding sulfuric acid.

14. The apparatus in accordance with claim 13 wherein the first precipitation tank is configured to raise the pH of the first eluent to about 10 or more by adding sodium hydroxide.

15. The apparatus in accordance with claim 11 wherein the second precipitation tank is configured to form ferrimolybdate by lowering the pH of the second eluent to between about 2 and 3.

16. The apparatus in accordance with claim 15 wherein the second precipitation tank is further configured to form ferrimolybdate by adding ferric chloride.

17. The apparatus in accordance with claim 16 wherein the second precipitation tank is further configured to form ferrimolybdate by maintaining the pH of the second eluent between about 2 and 3 while the ferric chloride is being added.

18. The apparatus in accordance with claim 17 wherein the second precipitation tank is configured to maintain the pH of the second eluent between about 2 and 3 while the ferric chloride is being added by adding sodium bicarbonate.
